(19) United States
(12) Patent Application Publication
(10) Pub. No.: US 2020/0079333 A1
(43) Pub. Date: Mar. 12, 2020

(54) Electric Energy Consumption Optimization Method Of A Plurality Of Vehicles, Associated Computer Product Program, And Driving And Supervision Automatic Systems

(71) Applicant: ALSTOM Transport Technologies, Saint-Ouen (FR)

(72) Inventors: Javier BALLESTEROS, Paris (FR); Felipe PAIVA, Paris (FR)

(21) Appl. No.: 16/563,709

(22) Filed: Sep. 6, 2019

(30) Foreign Application Priority Data
Sep. 6, 2018 (FR) 18 58007

(51) Int. Cl. B60T 8/17; B61L 3/00; B61L 27/00; B61L 27/04

(52) U.S. Cl. CPC B60T 8/1705; B61L 27/04; B61L 27/0027; B61L 3/006

(57) ABSTRACT

The present invention relates to a method for optimizing electric energy consumption of a plurality of vehicles connected to a same electric energy supply section. The method includes a step for determining (110) a preferred driving profile of a vehicle based on a current position of the vehicle and a destination of the vehicle, each preferred driving profile including a plurality of timeslots and for each timeslot, a desired traction value and/or a desired braking value. The method further includes steps for sending (120) of the preferred driving profile to an ATS system, acquisition (130) by an ATO system of the vehicle of an optimized driving profile generated by the ATS system, and application (140) of the optimized driving profile to the driving of the vehicle.

### FIELD OF THE INVENTION

The present invention relates to a method for optimizing electric energy consumption of a plurality of vehicles.

The present invention also relates to an associated computer program product and automated driving and supervision systems.

In particular, the present invention makes it possible to optimize the electricity consumption of a plurality of rail vehicles traveling on a same electric section and each having an automated driving system, called ATO (Automatic Train Operation) system, which is supervised by an ATS (Automatic Train Supervision) system.

### BACKGROUND OF THE INVENTION

In a known manner, a rail vehicle, in particular a train, includes two parallel braking systems.

One of these systems is a mechanical braking system, using mechanical braking means that guarantee a rapid deceleration of the train. This system is generally used when the train has a relatively low speed, which is for example the case when the train performs operational stops.

The other system is an electric braking system, using the engines of the train as generators of electric energy to reduce the speed of the train. This system is generally usable when the train has a relatively high speed.

In such a case, the electric energy generated during braking phases is dissipated via suitable resistances or is injected into the electric grid powering the corresponding electric section.

Thus, when two trains travel in the same electric section with a first train for example located in an acceleration phase, the electric energy injected on the grid by a second train in the braking phase can be recovered by the first train. Otherwise, this energy is dissipated by the grid and is therefore lost. It is also possible to store this energy so that it can be used later, but such a solution often has a very high cost.

One can then see that there is a need to optimize braking and acceleration phases of different trains traveling on a same electric section.

To that end, the state of the art proposes to synchronize the departure and arrival times of these different trains to optimize their most significant acceleration and braking phases. This therefore results in optimizing the electrical consumption of all of the trains traveling on a same electric section.

The schedules thus obtained are stored in the ATS system, which then defines the departures and arrivals of the trains.

However, such an operating mode takes into account only the most significant acceleration and braking phases, which does not make it possible to effectively limit the electrical consumption on the considered electric section. Furthermore, the processing done does not take into account any driving strategies developed by the ATO system of each of the trains.

Lastly, this operating mode is based on the set schedules is then unsuitable for example in case of delays of one or several of the trains.

### SUMMARY OF THE INVENTION

The present invention aims to resolve these drawbacks and therefore to propose a method and a system making it possible to optimize the electric consumption of vehicles connected to a same electric supply section that takes into account any delays of these vehicles as well as any other unexpected event.

To that end, the invention relates to an electric energy consumption optimization method of a plurality of vehicles connected to a same electric energy supply section, each vehicle comprising:
a traction system able to drive the corresponding vehicle in motion based on a traction value,
a braking system able to slow down the corresponding vehicle based on a braking value and to inject electric energy recovered after the braking, and
an automatic train operation (ATO) system, able to communicate remotely with an automatic train supervision (ATS) system;

the method including the following steps, carried out by the ATO system of each of the vehicles:
determining a preferred driving profile of the corresponding vehicle based on a current position of the vehicle and a destination of the vehicle, each preferred driving profile including a plurality of timeslots and for each timeslot, a desired traction value and/or a desired braking value;
sending the preferred driving profile to the ATS system;
acquiring an optimized driving profile generated by the ATS system, the optimized driving profile being determined based on preferred driving profiles sent to the ATS system by all of the vehicles connected to said electric section and including, for each timeslot of the corresponding preferred driving profile, an optimized traction value and/or an optimized braking value, in order to minimize the electric energy consumption in said electric section;
applying the optimized driving profile to the driving of the corresponding vehicle.

According to other advantageous aspects of the invention, the method comprises one or more of the following features, considered alone or according to all technically possible combinations:
the preferred driving profile further includes, for each timeslot, a minimum traction value and/or a maximum traction value defined by operational constraints of the corresponding vehicle;
the preferred driving profile further includes, for each timeslot, a maximum braking value defined by operational constraints of the corresponding vehicle;
the optimized driving profile is determined so as to respect the minimum traction value and/or the maximum traction value and/or the maximum braking value in each timeslot;
the optimized driving profile is determined so as to respect at least one of the criteria chosen from the following group:
   for each timeslot, minimization of the difference between a total attraction force corresponding to a sum of the optimized traction values of all of the vehicles in said electric section and a total braking force corresponding to a sum of the optimized braking values of all of the vehicles in said electric section;
   for each timeslot, limitation of a total traction force corresponding to a sum of the optimized traction values of all of the vehicles in said electric section;
   assignment of an unauthorized traction value and/or braking value in a given timeslot, to an adjacent timeslot.
the method further includes an initial step for determining a plurality of possible driving profiles of the corresponding vehicle based on its current position and its destination, each possible driving profile including a plurality of timeslots and for each timeslot, a possible traction value and/or a possible braking value; the preferred driving profile being chosen from among the plurality of possible driving profiles;
the step for applying the optimized driving profile to the driving of the corresponding vehicle comprises at least one of the following features:
   compliance with the optimized traction value for each timeslot;
   compliance with the optimized braking value for each timeslot when this value makes it possible to respect the operational constraints of the corresponding vehicle and otherwise, application of the desired braking value in the corresponding timeslot;
   shift of the initially scheduled departure time and/or arrival time;
the optimized driving profiles are sent to the vehicles by wireless signals, preferably in the form of public messages.

The invention also relates to a computer program product including software instructions which, when implemented by computer equipment, carry out the method as previously defined.

The invention also relates to an automatic train operation (ATO) system, for a vehicle connected to an electric energy supply section, the vehicle comprising:
a traction system driving the movement of the corresponding vehicle based on a traction value, and
a braking system braking the corresponding vehicle based on a braking value and injecting electric energy recovered after the braking in said electric zone;

the ATO system being able to communicate remotely with an automatic train supervision (ATS) system, and including technical means configured to implement the steps of the method as defined above.

The invention also relates to an automatic train supervision (ATS) system, able to communicate remotely with one or several ATO systems as defined below to receive preferred driving profiles generated by these ATO systems and including technical means configured to determine an optimized driving profile from these preferred driving profiles.

### BRIEF DESCRIPTION OF THE DRAWINGS

These features and advantages of the invention will appear upon reading the following description, provided solely as a non-limiting example, and done in reference to the appended drawings, in which:

FIG. 1 is a schematic view of a plurality of rail vehicles traveling on a same electric section and each including an automatic train operation system according to the invention supervised by an automatic train supervision system according to the invention; and

FIG. 2 is a flowchart of an optimization method according to the invention, the method being implemented by the automatic train operation systems and the automatic train supervision system of FIG. 1.

### DETAILED DESCRIPTION OF THE INVENTION

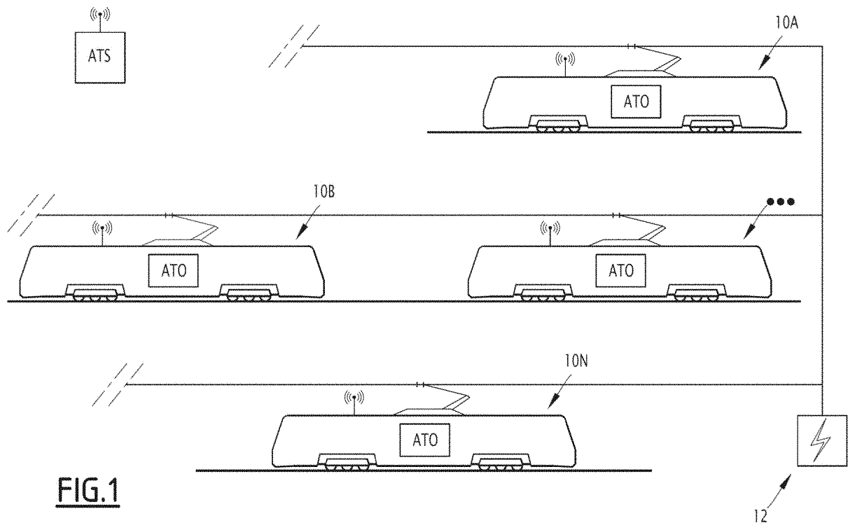

The vehicles 10A, . . . , 10N of FIG. 1 are advantageously rail vehicles, for example trains, in particular automatic trains or trains at least partially controlled by conductors, for example subway trains.

In a variant, the vehicles are electric buses or trams.

The rail vehicles 10A, . . . , 10N for example travel on several railroad tracks, which are optionally parallel or adjacent, and can be supplied when they travel on these tracks by means of a same electric energy supply section 12.

In particular, such an electric section 12 includes shared electric energy transmission means making it possible to at least partially supply each of the rail vehicles 10A, . . . , 10N, when they travel on the railroad tracks associated with said electric energy section, and to implement exchanges of surplus electric energy between these different vehicles 10A, . . . , 10N using methods known in themselves.

The rail vehicles 10A, . . . , 10N travel on the corresponding tracks according to operational constraints determined by each of these vehicles.

The operational constraints in particular define the path of the vehicle 10A, . . . , 10N, its operational stopping points, the topology of the track, the distance from adjacent vehicles, the traffic regulations, etc.

Each rail vehicle 10A, . . . , 10N in particular includes a traction system and an electric braking system.

The traction system includes one or several motors making it possible to set the corresponding rail vehicle 10A, . . . , 10N in motion using the electric energy supplied by the electric section 12. The operation of this system is defined at each moment by a traction value for example corresponding to a percentage of the total force that this system is able to supply.

The electric braking system makes it possible to slow down the movement of the corresponding rail vehicle 10A, . . . , 10N by using the motors of the traction system as generators. This braking system further makes it possible to inject the electric energy generated by the motors into the electric section 12.

The operation of the braking system is defined at each moment by a braking value for example corresponding to a percentage of the total force that this system is able to exert in order to slow down the corresponding rail vehicle.

Each rail vehicle 10A, . . . , 10N further includes an automatic train supervision system, called ATO system.

This ATO system in particular makes it possible to define a driving profile of the corresponding rail vehicle 10A, . . . , 10N, according to which the driving of this vehicle is done at least partially automatically. This driving profile is in particular determined based on operational constraints of the corresponding vehicle 10A, . . . , 10N.

The operation of each ATO system is supervised by an automatic train supervision system, called ATS system.

The ATS system is a remote system for example arranged in a remote control station. This ATS system is able to communicate remotely with each of the ATO systems via electromagnetic signals, in particular via wireless signals.

Each ATO system and the ATS system for example at least partially assume the form of computers, each computer being provided with a memory and a processor able to execute software stored in this memory. According to one embodiment variant, at least some of these systems further comprise programmable logic circuits, for example of the FPGA (Field-Programmable Gate Array) type, making it possible to at least partially implement the functions provided by these systems. According to another embodiment variant, at least some of the aforementioned systems entirely assume the form of such circuits.

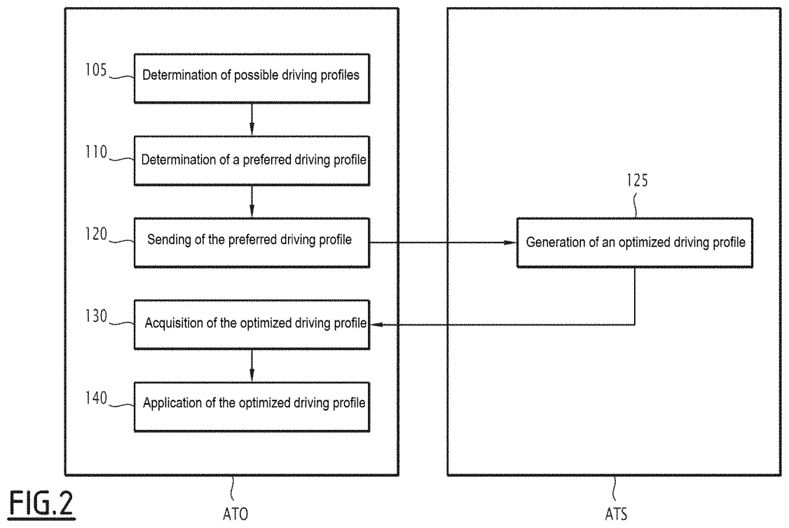

The ATO systems of the rail vehicles 10A, . . . , 10N and the ATS system make it possible to implement the electric energy consumption optimization method in the electric section 12, which will now be described in reference to FIG. 2, showing a flowchart of its steps.

The steps described below are implemented by each of the ATO systems and the ATS system. In order to simplify the reading, these steps will be explained below in connection with a single ATO system, for example that of the rail vehicle 10A. The implementation of these steps in connection with the other ATO systems is similar.

Furthermore, the steps implemented by the ATO systems are implemented at least once by each ATO system, for example simultaneously, and then by at least some of these ATO systems, upon each change of operational constraints, and in particular of the driving profile, of the corresponding vehicles.

During an initial step 105, the ATO system determines a plurality of possible driving profiles of the rail vehicle 10A.

These profiles are for example determined based on the current position of the vehicle 10A and its destination as well as based on other operational constraints during this journey.

Each driving profile comprises a plurality of timeslots, and for each timeslot, a traction value defining the operation of the traction system during this slot and a braking value defining the operation of the braking system during this slot.

The timeslots define the consecutive moments of the journey of the corresponding rail vehicle. Each timeslot for example corresponds to several seconds, for example substantially to 10 seconds, of the journey.

During the following step 110, the ATO system determines, from among the possible driving profiles, a preferred driving profile of the rail vehicle 10A.

This preferred profile is for example determined so as to best respect the operational constraints of the vehicle 10A and optionally, so as to minimize the electric energy consumption of this vehicle 10A by using consumption data known by the ATO system of this vehicle 10A.

Each preferred driving profile therefore includes a plurality of timeslots, and for each timeslot, a desired traction value and a desired braking value during this timeslot.

In particular, the desired traction and braking values respectively correspond to the traction and braking values that the ATO system deems most appropriate for the corresponding timeslots, in particular based on the operational constraints of the rail vehicle 10A.

Advantageously, each preferred driving profile further includes, for each timeslot, a minimum traction value, a maximum traction value and a maximum braking value that are also determined based on operational constraints of the rail vehicle 10A.

In particular, the minimal traction value indicates the minimal force that the traction system must provide during the corresponding timeslot in order for example to avoid situations with a lack of energy on uphill gradients and/or to ensure a normal departure of the vehicle 10A from a stopping point.

The maximal traction value indicates the maximal force that the traction system is authorized to provide during the corresponding timeslot in order for example to avoid overspeed situations on turns or downhill gradients. In timeslots corresponding to operational stopping points of the vehicle, the maximal traction value is equal to zero.

The maximal braking value indicates the maximal force that the braking system is authorized to provide during the corresponding timeslot. In timeslots corresponding to operational stopping points of the vehicle, the maximal braking value is equal to zero.

Advantageously, each preferred driving profile further includes, for each timeslot, an estimated distance to be traveled by the vehicle 10A during this timeslot.

During the following step 120, the ATO system sends the preferred driving profile to the ATS system. This sending is for example done by wireless links with this ATS system.

During the following step 125, the ATS system requires the preferred driving profile from the ATO system of the vehicle 10A and generates an optimized driving profile for this vehicle 10A.

The optimized driving profile is determined based on preferred driving profiles sent by all of the rail vehicles 10A, . . . , 10N of the electric section 12 to the ATS system.

In particular, the optimized driving profile determined for the vehicle 10A includes, for each timeslot of the preferred driving profile sent by the ATO system of this vehicle 10A, an optimized traction value and an optimized braking value, making it possible to minimize the electric consumption in the electric section 12.

The optimized driving profile for the vehicle 10A is determined by the ATS system so as in particular to comply, in each timeslot, with the minimum traction value, the maximum traction value and the maximum braking value, which are defined by the preferred driving profile of the vehicle 10A.

Advantageously, the optimized driving profile for the vehicle 10A is further determined so as to minimize, for each timeslot, the difference between a total traction force and a total braking force in the electric section 12.

In particular, the total traction force in the electric section 12 at a given moment corresponds to a sum of the optimized traction values of all of the rail vehicles 10A, . . . , 10N in this electric section 12 at this moment. This sum is for example weighted based on the positions of these vehicles and the topology of the electric energy grid or based on any other optimization criterion.

Similarly, the total braking force in the electric section 12 at a given moment corresponds to a sum of the optimized braking values of all of the rail vehicles 10A, . . . , 10N in this electric section 12 at this moment. This sum is for example weighted based on the positions of these vehicles and the topology of the electric energy grid or based on any other optimization criterion.

The minimization of the aforementioned difference is for example done by aligning the acceleration phases of some of the vehicles 10A, . . . , 10N with the deceleration phases of other vehicles, by optionally modifying the arrival and/or departure times of at least some of these vehicles 10A, . . . , 10N.

Advantageously, the optimized driving profile for the vehicle 10A is further determined so as to minimize, for each timeslot, the difference between a total traction force and a total braking force in the electric section 12.

This total traction force is limited by a consumption threshold imposed for example by the supplier of the electric energy or by any other type of constraint.

Advantageously, the optimized driving profile for the vehicle 10A is further determined so as to assign an unauthorized traction value and/or braking value in a given timeslot, to an adjacent timeslot.

Thus for example, when a traction or braking value considered to be optimal by the ATS system in a given timeslot is not authorized by the preferred driving profile of the ATO system of this timeslot but is authorized in an adjacent timeslot, the ATS system assigns this traction or braking value to this adjacent timeslot.

A timeslot adjacent to a given timeslot refers to a timeslot immediately adjacent to this given timeslot or separated therefrom by a value below a predetermined threshold that is for example equal to several tens of seconds.

At the end of this step 125, the ATS system sends the optimized driving profile to the ATO system of the vehicle 10A.

This profile is for example sent by wireless signals, preferably in the form of public messages, for example using broadcast technology.

More generally, during step 125, the ATS system generates/determines an optimized driving profile for each vehicle supplied by the electric section 12 and at the end of step 125, sends each vehicle the optimized profile that is associated with it and advantageously the optimized profile of all of the vehicles supplied by the electric section 12.

For example, each time a vehicle supplied by the electric system 12 sends a modified preferred driving profile to the ATS system, the ATS system generates/determines a new optimized driving profile for each vehicle supplied by the electric section 12 and at the end of step 125, sends each vehicle the optimized profile that is associated with it and advantageously the optimized profile of all of the vehicles supplied by the electric section 12.

In a variant, each time the ATO system of one of the vehicles modifies the driving profile that it applies to the driving of the vehicle (case of unexpected braking, overspeed, etc.), it sends the driving profile applied to the ATS system as preferred driving profile and the latter generates/determines a new optimized driving profile for each vehicle supplied by the electric section 12.

According to another variant, step 125 is repeated regularly with a predetermined frequency and new optimized driving profiles are calculated and sent to the vehicles repeatedly.

During the following step 130, the ATO system acquires the optimized driving profile sent by the ATS system and optionally the optimized profile of all of the vehicles supplied by the electric section 12.

During the following step 140, the ATO system applies the optimized driving profile to the driving of the vehicle 10A.

In particular, during this step 140, the ATO system monitors the operation of the traction system of the vehicle 10A by imposing a traction value for each timeslot corresponding to the optimized traction value for this timeslot according to the optimized driving profile.

Moreover, the ATO system monitors the operation of the braking system of the vehicle 10A by imposing a braking value for each timeslot.

This braking value corresponds to the braking value optimized by the ATS system when this braking value makes it possible to comply with the operational constraints of the rail vehicle 10A during the corresponding timeslot.

Otherwise, the imposed braking value is determined by the ATO system dynamically based on the operational constraints, in particular in order to comply with the maximum authorized speed in the corresponding timeslot.

Thus for example, when the vehicle 10A is on a downhill gradient and when the optimized braking value is insufficient to prevent an overspeed of the vehicle 10A on this gradient, the ATO system imposes a higher braking value in order to avoid this overspeed. This braking value is therefore determined dynamically.

Lastly, the application of the optimized driving profile can involve shifts of the departure time and/or the arrival time that are initially determined for at least some operational stopping points.

One can then see that the invention has a certain number of advantages.

In particular, the invention makes it possible to optimize the electric energy consumption of rail vehicles traveling in a same electric section, dynamically.

Thus, in case of delays or any changes in the schedules of these vehicles, the invention makes it possible to adopt new schedules quickly, minimizing the electric energy consumption in the entire electric section.

Furthermore, the invention makes it possible to limit electric energy consumption peaks in the given electric section. This for example makes it possible to comply with consumption constraints imposed by the corresponding electric energy supply means or by the electric energy supplier.

1. An electric energy consumption optimization method of a plurality of vehicles connected to a same electric energy supply section, each vehicle comprising:
a traction system able to drive the corresponding vehicle in motion based on a traction value,
a braking system able to slow down the corresponding vehicle based on a braking value and to inject electric energy recovered after the braking, and
an automatic train operation system, called ATO system, able to communicate remotely with an automatic train supervision system, called ATS system;
the method including the following steps, carried out by the ATO system of each of the vehicles:
determining a preferred driving profile of the corresponding vehicle based on a current position of the vehicle and advantageously a destination of the vehicle, each preferred driving profile including a plurality of timeslots and for each timeslot, a desired traction value and/or a desired braking value;
sending the preferred driving profile to the ATS system;
acquiring an optimized driving profile generated by the ATS system, the optimized driving profile being determined based on the preferred driving profiles sent to the ATS system by all of the vehicles connected to said electric section and including, for each timeslot of the corresponding preferred driving profile, an optimized traction value and/or an optimized braking value, in order to minimize the electric energy consumption in said electric section;
applying the optimized driving profile to the driving of the corresponding vehicle.

2. The method according to claim 1, wherein the preferred driving profile further includes, for each timeslot, a minimum traction value and/or a maximum traction value defined by operational constraints of the corresponding vehicle.

3. The method according to claim 1, wherein the preferred driving profile further includes, for each timeslot, a maximum braking value defined by operational constraints of the corresponding vehicle.

4. The method according to claim 2, wherein the preferred driving profile further includes, for each timeslot, a minimum traction value and/or a maximum traction value defined by operational constraints of the corresponding vehicle; and
wherein the optimized driving profile is determined so as to respect the minimum traction value and/or the maximum traction value and/or the maximum braking value in each timeslot.

5. The method according to claim 1, wherein the optimized driving profile is determined so as to respect at least one of the criteria chosen from the following group:
for each timeslot, minimization of the difference between a total attraction force corresponding to a sum of the optimized traction values of all of the vehicles in said electric section and a total braking force corresponding to a sum of the optimized braking values of all of the vehicles in said electric section;
for each timeslot, limitation of a total traction force corresponding to a sum of the optimized traction values of all of the vehicles in said electric section;
assignment of an unauthorized traction value and/or braking value in a given timeslot, to an adjacent timeslot.

6. The method according to claim 1, further including an initial step for determining a plurality of possible driving profiles of the corresponding vehicle based on its current position each possible driving profile including a plurality of timeslots and for each timeslot, a possible traction value and/or a possible braking value;
the preferred driving profile being chosen from among the plurality of possible driving profiles.

7. The method according to claim 1, wherein the step for applying the optimized driving profile to the driving of the corresponding vehicle comprises at least one of the following features:
compliance with the optimized traction value for each timeslot;
compliance with the optimized braking value for each timeslot when this value makes it possible to respect the operational constraints of the corresponding vehicle and otherwise, application of the desired braking value in the corresponding timeslot;
shift of the initially scheduled departure time and/or arrival time.

8. The method according to claim 1, wherein the optimized driving profiles are sent to the vehicles by wireless signals.

9. The method according to claim 1, wherein during the determining the preferred profile of the corresponding vehicle is further determined based on a destination of the vehicle.

10. The method according to claim 9, further including an initial step for determining a plurality of possible driving profiles of the corresponding vehicle based on its current position and its destination, each possible driving profile including a plurality of timeslots and for each timeslot, a possible traction value and/or a possible braking value;
the preferred driving profile being chosen from among the plurality of possible driving profiles.

11. A computer program product comprising software instructions which, when implemented by a piece of computer equipment, carry out the method according to claim 1.

12. An automatic train operation system, called ATO system, for a vehicle connected to an electric energy supply section, the vehicle comprising:
a traction system driving the movement of the corresponding vehicle based on a traction value, and
a braking system braking the corresponding vehicle based on a braking value and injecting electric energy recovered after the braking in said electric section;
the ATO system being able to communicate remotely with an automatic train supervision system, and including technical means configured to implement the steps of the method according to claim 1.

13. An automatic train supervision system, called ATS system, able to communicate remotely with one or several ATO systems according to claim 12 to receive preferred driving profiles generated by these ATO systems and including technical means configured to determine an optimized driving profile from these preferred driving profiles.
